(19) United States
(12) Patent Application Publication
(10) Pub. No.: US 2024/0116093 A1
(43) Pub. Date: Apr. 11, 2024

(54) COMPOSITIONS AND METHODS FOR LONG-TERM CARBON STORAGE IN THE DEEP SEA USING A FREE FALL PENETRATOR

(71) Applicant: Sinkco Labs, Lewes, DE (US)

(72) Inventor: Victor Adrian Daniel Choquet, Paris (FR)

(21) Appl. No.: 18/483,823

(22) Filed: Oct. 10, 2023

Related U.S. Application Data
(60) Provisional application No. 63/415,160, filed on Oct. 11, 2022.

(51) Int. Cl. B09B 1/00; B65G 1/02

(52) U.S. Cl. CPC B09B 1/002; B65G 1/02

(57) ABSTRACT

The herein invention encompasses systems and processes required for the application of a sea freefall penetrators containing C-rich material allowing long-term C storage in deep sea sediments. The invention encompasses methods of manufacturing in the form of carbon made structure, the operational parameters such as the overall density, dimension and data obtained in field trials to successfully bury atmospheric carbon in deep-sea sediment, and the process acting in its geological storage.

### CROSS-REFERENCE TO RELATED APPLICATION

This application claims the benefit of and priority to U.S. Provisional Application No. 63/415,160, filed Oct. 11, 2022, and is incorporated herein by reference in its entirety.

### FIELD OF THE INVENTION

The invention encompasses systems and processes for the permanent storage of carbon or a carbon source in the ocean using a carbon rich freefall penetrator that buries into the ocean bed substrate. In various embodiments, the invention encompasses methods for the design and characteristics of the penetrator, filling methods, and delivery system for carbon storage. The penetrating compositions comprises several ranges of dimension relative to the composition of the carbon rich filling including algae, algae residue material, and carbon carbon-rich material.

### BACKGROUND OF THE INVENTION

The present invention refers to a novel method for long-term, storage of algae residual biomass (ARB) in deep-sea sediments. The following description refers especially to seabed penetrators containing the ARB, which are dropped from sea vessels freefalling and burying in deep-sea sediments (>1,000 m depth).

Currently, climate change, as defined by the World Health Organization (WHO), is the greatest threat to global health and, since the 1800s, human activities have driven these phenomena causing heat-trapping gas (“greenhouse gas,” GHG) levels to increase in the atmosphere. Among these gasses, carbon dioxide (CO₂) has now reached alarming concentrations (420.23 ppm, April 2022, NOAA) creating problems for human health. Evidence of climate change is now compelling, from warming oceans to shrinking ice sheets, sea level rise and the increasing numbers of extreme events. Its effects are irreversible on the timescale of people alive today and will likely worsen in the coming years.

Therefore, the world must find a way now to reduce GHG emissions and CO₂ concentrations in the atmosphere to limit and slow global warming and its increasing costs. The international community is coming together to find solutions and develop strategies for atmospheric CO₂ removal and sequestration; however, these technologies and procedures often require considerable efforts and energy to be put into place. Carbon dioxide removal (CDR) technologies and solutions are increasing with the ocean being one of the viable and best solutions at present. Macroalgae have long attracted the attention of the international community for their important role in the growing blue economy sector and their ability for atmospheric CO₂ sequestration.

The present invention adapts a concept developed for the disposal of waste material into the seabed and establishes a novel CDR technology for long-term storage of CO₂ into deep-sea sediments. The compositions include an organic and biodegradable sleeve containing carbon (C)-rich algae material providing a more durable and environmentally friendly solution to current CDR technologies.

The latest IPCC report confirms the irreversible damages to natural and human systems as the sudden climate extremes go beyond the Earth's ability to adapt and invites world governance to promote climate resilient development. The concepts of carbon offset and carbon mitigation strategies have only recently started to emerge with no legislations or regulatory bodies classifying existing approaches and solutions. Although there is a growing market for carbon-negative products with seemingly positive impacts, the actual effects on global warming reduction remain still unknown.

Thus, the immediate need for atmospheric CO₂ removal and long-term storage of carbon contributes to mitigate the current climate crisis. The ocean, and more in particular the deep-sea, is a vast and mostly unknown environment providing us with services that are crucial for our lives^{9,10}. It has long helped us to mitigate the effects of climate change by acting as a major carbon sink and cycling carbon on ˜4000-year timescales. Among the current solutions, ocean CDR already presents multiple approaches and offers several opportunities for further development¹. Within this context, carbon burial in deep-sea sediments offers the prospect to sequester atmospheric CO₂ on geological timescales (thousands to millions of years)⁹.

Thus, with this novel ocean CDR technology, we aim to support the climate crisis mitigation efforts increasing the ocean capacity to sequester atmospheric CO₂.

### SUMMARY OF THE INVENTION

In various embodiments, the invention encompasses system for the permanent storage of carbon in the ocean using freefall penetrator device comprising
a. a tubelike composition capable of delivery to the ocean floor and capable of penetrating the ocean floor; and
b. a hollow internal portion capable of containing carbon waste.

In certain embodiments, the system allows a cost and energy efficient tool for ocean CDR that stores and sequesters atmospheric carbon for a period of time with minimal risk of harm to the deep-sea benthic ecosystem.

In certain embodiments, the carbon stored is atmospheric and/or from anthropogenic activities, and it is stored for a period of time to allow removal of carbon from the atmosphere.

In certain embodiments, the energy efficiency methods are used for steps a, b, or c, and wherein carbon storage capacity is increased, emission to removal ratio is reduced, and carbon offset value increases.

In certain embodiments, the penetrating device for ocean carbon dioxide removal (CDR) generates C-offset by the removing atmospheric CO₂ and permanently disposing of C-rich materials.

In certain embodiments, the penetrating device is comprised of organic and/or inorganic carbon, or a combination thereof and results in no harm to the ecosystem does not affect any ecotoxicity for the food chain by bioaccumulation of harmful compounds.

In certain embodiments, the penetrating device allows the potential of using organic waste carbon with no required process.

In certain embodiments, the size of the penetrating device possesses greater that 1.5 L volume capacity, carbon content, carbon storage capacity, and a cost efficiency as a CDR storage composition.

In certain embodiments, the composition has a volume of about 3 L or more.

In certain embodiments, the penetrating device has dimensions and density that allow penetration into the seabed and long-term storage of its carbon content material.

In certain embodiments, the penetrating device has a cumulative risk between 1 and 10%.

In certain embodiments, the penetrating device has a length of about 5 m and L/D ratio between 8 and 15, and a density higher or equal to 1650 kg·m⁻³.

In certain embodiments, the penetrating device manufacturing plant has direct access to the seaway.

In certain embodiments, the penetrating device is comprised of external material and internal filling made directly to capture carbon into structural material, which can greatly benefit from the carbon storage composition.

In certain embodiments, the penetrating device includes a mechanism to allow delivery of to the burial zone of the ocean from a boat.

In certain embodiments, the penetrating device is included in modified containers for the transport by sea and such modified containers are equipped with quick release hooks or similar that are loaded at a later stage.

In certain embodiments, specialized bulk carrier vessels are used for transporting Sinkcores, simplifying legal compliance and providing a stable CO₂ sequestration cost structure.

In certain embodiments, the penetrating device comprises a tail that allows the composition to penetrate into the sediment about 1 to 30 m depth to allow a long-term storage of C.

In certain embodiments, the penetrating device stored in the deep-sea sediment avoids the disturbance to the benthic ecosystem, shorter storage of the carbon due to is respiration (organic carbon) or leakage for inorganic carbon in the seabed water bodies and return to the surface with the ocean thermocline cycle. In specific conditions, sulfur-driven decomposition allows for shallower burial depths. In certain embodiments, methanogenesis occurs when sulfur concentrations are limited, allowing for flexible burial depths and sediment types.

In certain embodiments, the operation of the penetrator composition uses a spacing distance for flight that allows to diminish the overall cumulative risk of composition to resurface.

In certain embodiments, the penetrating device manufacturing cost, its size, and its carbon content are the most important factors defining the efficiency of such inventions of ocean CDR.

While carbon footprint refers to the amount of CO₂ released into the atmosphere by an individual or other entity, carbon offset is the system where these individuals or entities reduce their carbon footprint by paying money to a company responsible to partake in CDR solutions. The Oxford Offsetting Principles classifies carbon offsets in five different categories based on whether carbon is stored and its storage method¹¹. Type I-III are limited to carbon emission reduction while Type IV-V consider carbon removal. The average cost of a carbon Type V carbon credit is $600/tCO₂.

The rush to find new strategies to sequester atmospheric CO₂ has started. The marine environment contains already many naturally occurring elements that sequester atmospheric CO₂ and act as natural carbon sinks known also as blue carbon mitigators, ranging from seagrass meadows to salt marshes and mangroves. Among these, macroalgae are receiving a growing interest for their role in the blue carbon sector with recent studies hypothesizing that macroalgae can support an export of 152 TgC yr⁻¹ to the deep sea. There are now a growing number of strategies and projects supporting the use of macroalgae as a means for atmospheric carbon sequestration.

Macroalgae retain 25% of C in their biomass when harvested directly from the ocean and ˜30% when farmed⁵ and in addition can provide further compounds useful for everyday products. Table 1 presents compound repartition and C content for an algal blend composed by 70% Ulva lactuca and 30% Sargassum muticum (Sinkco Labs Provisional Patent 44165080) where C is usually retained in the algae supporting the potential of this invention as a novel ocean CDR technology.

The invention takes advantage of the natural photosynthetic ability of macroalgae to capture atmospheric CO₂, ultimately using the same algae to produce C-negative compounds. Following biorefinery processes, the residual algae biomass (Table 1) is buried into deep-sea sediment for long-term C storage. This approach provides a novel strategy to current ocean CDR technologies as now organic C-rich loads are deposited on the seabed with unknown consequences to local and regional biodiversity and ecosystem function.

TABLE 1
This table presents compound weights found in an algal blend of 70% Ulva lactuca
and 30% Sargassum muticum, C-content and percentage of each compound, amount
of remaining C following extraction process of the relative C compounds and the equivalent
in CO₂ (g CO₂/100 g dry algae). Units are expressed as g/100 g dry algae. Taken
from Sinkcolabs Provisional Patent 44165080.

| | | | | | C-content | CO₂ eq |
|---|---|---|---|---|---|---|
| | | | Amount of | C-content | following | relative |
| | Total | Amount of | C in each | following | compound | to the |
| | compound | C in each | algal | compound | extraction | total |
| | amount in | algal | compound | extraction | process | C_{ARB} |
| | algal blend | compound | (%) | process | (%) | mass* |
| Polysaccharides | 64.0 | 23.7 | 37.1 | 8.5 | 26.3 | 31.1 |
| Lipids | 0.5 | 0.2 | 48.6 | 32.0 | 99.3 | 117.4 |
| Proteins | 15.0 | 8.2 | 54.9 | 24.0 | 74.4 | 88.0 |
| Ashes | 20.5 | 0.0 | 0.0 | 32.2 | 100.0 | 118.2 |
| Total | 100 | 32 | — | — | — | — |

*NB: Assuming 100% ARB recovery.

First efforts to better understand the deep-sea potential for C sequestration included direct injection of liquid CO₂ into the deep sea where the deep-seabed was exposed to low-pH conditions with negative impacts near CO₂ pools. The scientific consensus agrees that once carbon, whether dissolved or organic, sinks below 1,000 m, it is successfully sequestered from the atmosphere for ˜1,000 years due to the global ocean circulation patterns cycling waters from the surface to the deep sea and back in contact with the atmosphere. A more successful solution is presented by seaweed aquaculture beds (SABs), particularly widespread in the Asian-Pacific region, which provide numerous important ecosystem services and play a key role in CO₂ mitigation efforts contributing to annual accumulation of over 2.87×10⁻⁶ t CO₂ y⁻¹ for the Asian-Pacific region.

The invention encompasses compositions and methods including a environmentally friendly approach enhancing natural processes already present in the ocean and exploiting algae natural power to intake CO₂ avoiding injecting non-native compounds into the seabed. When the compositions including naturally occurring algae will be buried into the seabed below 1,000 m depth, the carbon contained in their biomass will be sequestered at geological timescales. This process acts as a better alternative of ocean CDR that avoids the common risks of ecosystem changed dynamic and leakage of carbon to the surface other CDR methods employed today with the use of algae cultivation and sinkage.

Predictions on the impacts of climate change on deep-sea benthic ecosystems shows quite a bleak future. The deep sea is considered an energy limited environment due to the small amount of particulate organic carbon (POC) (0.5-2% of net primary production¹⁷), thus food, that receives from surface waters and with the increasing effects of climate change on the marine environment this flux will decrease even more. Thus, if some of the ARB would leak back into the water, local fauna and organisms would benefit from this organic input.

Artificial sinking of organic matter in the ocean requires several permits and authorizations where several assumptions and concerns must first be tested to fully understand the impacts on deep-sea ecosystems.

The penetrator device of the invention includes the concept of penetrators for the purpose of geological C storage. In various embodiments, the density of the penetrator device of the invention varies between 500 to 7,500 kg m⁻³, preferably, the penetrating device density is in the range of about 1,000 to 5,000 kg m⁻³, more preferably about 1,200 to about 4,500 kg m⁻³.

In various embodiments, the burial depth of the penetrator device ranges from about 1 m to about 30 m.

### BRIEF DESCRIPTION OF THE FIGURES

FIG. 1 is a 2D side representation of a L=5.5 m long Penetrator device, diameter D=55 cm (L/D=10) according to values presented in table 2 of the example section.

FIG. 2 is a 2D back representation of a L=5.5 m long Penetrator device, diameter D=55 cm (L/D=10) according to values presented in table 2 of the example section.

FIG. 3 describes the general dimension parameters of the Penetrator device.

FIG. 4 describes the ogive radius of the Penetrator device nose.

FIG. 5 describes the general relation of the mathematical parameter of the Penetrator device burial process.

FIG. 6 describes the horizontal embodiment of the Trimmsy delivery system with Penetrator device of 2 m overall length (L=2 m), quick release system.

FIG. 7A) describes the dropping point (1) of a Penetrator device, the trajectory highway (2) and the burial zone (3). B) describes the dropping zone (1) of a Penetrator device, the trajectory highway (2), the burial area (3). C) describes the dropping zone (1) of a Penetrator device, the trajectory highway (2), the burial area (3) and the burial sediment layer (4).

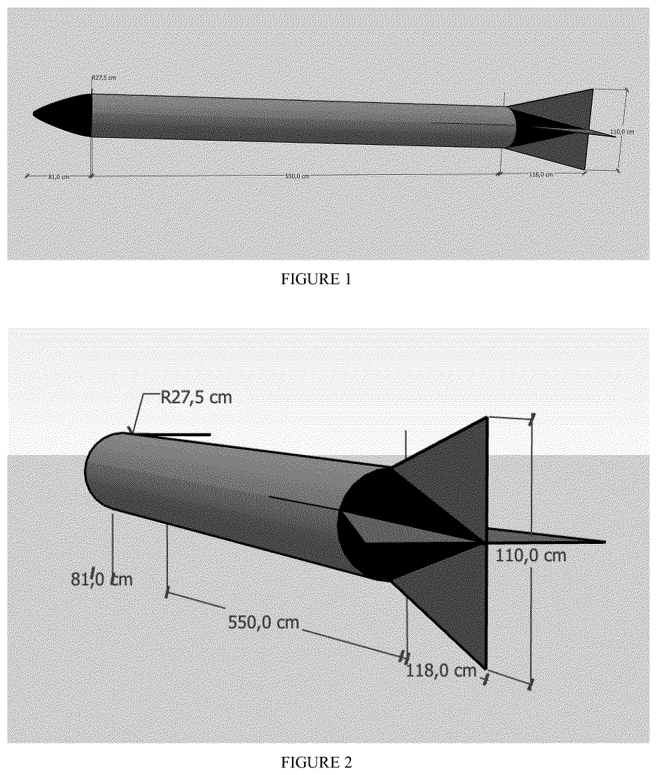

### DETAILED DESCRIPTION OF THE INVENTION

The invention encompasses a system, penetrator device, and methods of ocean CDR that allows for the long-term storage of atmospheric and or carbon from anthropogenic industries. The method uses freefall C compacted into one or more penetrator devices that penetrate into the sea floor at great depths, which use earth's gravitational force to store carbon in a safe and energetic efficient way. This invention encompasses all aspects of this process in three parts: from the dimension and structural material of the Penetrator devices, the Singapore's transport to burial zone and operations, down to its recorded parameters during field trial, and overall C storage capacity.

The invention encompasses, a penetrator device including a body, tail, and nose in three major embodiments:
a) components are made of organic material and fabric;
b) components are made of C-rich material; or
c) components are made of a mixture of ARB and carbon enriched material.

Preferably, the penetrator device is made of C-rich material.

In a first embodiment, the penetrator device comprises three major embodiments:
a) material is made of wet, dry, or compressed ARB
b) material is made of C-rich material.
c) materials are made of a mixture of ARB and C-rich material.

The various dimensions of the penetrator device comprise the relation between the overall length (L), length of the body (Lb), length the nose (Ln), length of the tail (Lt), its body diameter (D), and nose ogive radius (ρ_{Ogive}), tail fin width (Tf_{width}), and penetrator device overall density (ρ_{Penetrator device}), where:
a) L=Ln+Lb+Lt
b) Ratio L/D is about 5 to about 20, preferably 10 to 15;
c) Ratio L/Lt is about 0.3 to about 0.07;
d) ρ_{Ogive} is about 1.D to 8.D
e) Tf_{width} is about 0.8×D to about 1.2×D
f) ρ_{Penetrator device} is about 1,200 to about 7,500 kg m⁻³

The invention further comprises a penetrator device, wherein:
a) the overall cost is less than the C it contains;
b) the preferred embodiment of the herein invention uses atmospheric C sources;
c) The overall carbon footprint (CF) of the penetrator device overall manufacturing and operational process is less than the C contained in the Penetrator device (see example section); and
d) capable of turning gaseous CO₂ (atmospheric or avoided) liquid CO₂ (atmospheric or avoided), into penetrator device structural or filling material is highly compatible for integration to the herein invention.

In various embodiments, the penetrator device can be transported to burial zones and operations, wherein:
a) manufacturing plant should be located close to a port or a ship terminal to facilitate the transport of the finished product onto vessels;
b) containers possess a sea catch, or similar;
c) transport and immersion system is added to a containers vessel;
d) The transport and immersion system contains one or several mechanical racks where the penetrator device container hangs through or stands on a treadmill. The rack or treadmill is operated mechanically or manually. The transport and immersion system possesses an extension of the rack or treadmill that extends over the board of the ship, to allow the penetrator device or equivalent container to be released overboard and into the water column. Its extension includes a sleeve chute to ease the fall of the penetrator device or equivalent container into the ocean. The sleeve chute extends from the below part of the container, for the penetrator, ready to be launched, down to 10 m in the water column. The sleeve chute is slightly angled.

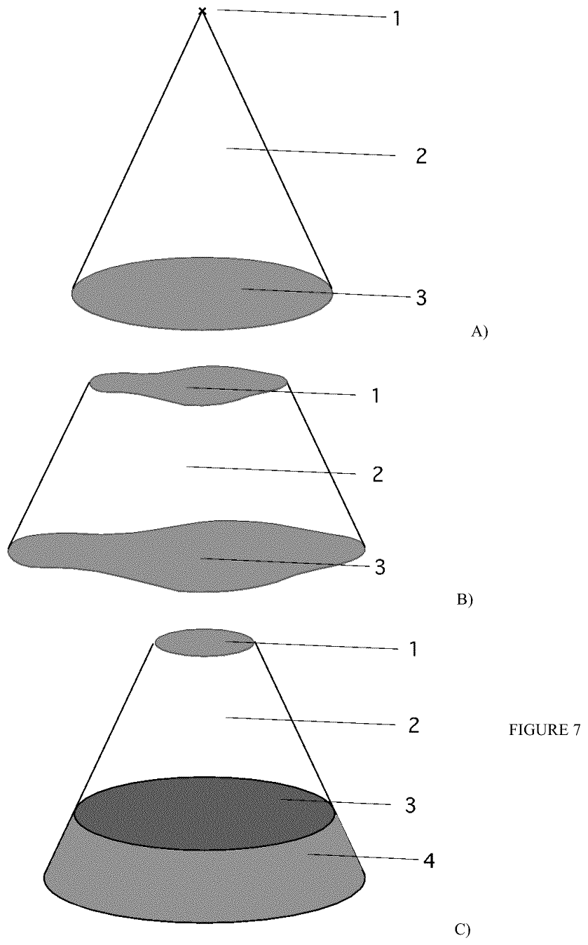

In other embodiments, the burial zone and the drop zone, comprise:
a) a drop point is specified as the geographic location where the penetrator device is dropped and starts its descent toward the seabed;
b) a burial zone is located below the dropping point and is therefore defined by a circular area in which the penetrator device terminates its water flight and starts its penetration in the sediment. The Penetrator device deviation in the vertical trajectory ranges from about 1 to about 25 degrees (see FIG. 7A);
c) a burial zone of a dropping point depends on the shape, size, and velocity of the Penetrator device used, but also by the physical factors of the water column at the time of the flight;
d) a C-burial into sediment is considered geologically stored only when the cumulative risk factor ranges from about 1 to about 5%;
e) a penetrator device highway is the area that links the drop point to the burial zone. It is the area where the Penetrator device carries its water flight. The Penetrator device highway must be free of any structural obstructions such as fishing lines, buoys, and erratic glaciers;
f) a device penetration layer is the place where the penetrator device buries. The penetration layer safety determines the safety of a burial zone. The burial site is the place where the penetrator device enters the sediment; and
g) the burial site does not present a zone of seismic record for more than 1 million years.

In various embodiments, different sediment types can constitute the sediment at a burial site including but not restricted to clay or calcareous ooze. Moreover, in various embodiments sediment should have at least one of the following characteristics: it must be thick, weak, homogeneous, and have very fine particles. For the Penetrator device's tail to bury at the desired depth and store carbon at geological time scale, the sediment must be composed by soft mud with particles size between 2 to 50 μm and permeability in the range of 10⁻³ cm s⁻¹ for coarse turbidites to 10⁻⁸ cm s⁻¹ for fine pelagic clays.

In various embodiments, the safety of the distance between each deployment and burial site, comprises:
a) a location of each drop is measured according to the cumulative risk of leakage. The cumulative risk of leakage should not result in an overall cumulative risk above 5% for the carbon to be stored.
b) a safety of the distance between each deployment must result in a 95% probability interval that the carbon does not leak to the seabed and pose a risk for the deep-sea ecosystem.

The third part of the detailed description discusses the parameters of the water flight and C storage. The parameters of the water flight includes:
a) a terminal velocity and the drag are affected by the weight of the penetrator device;
b) Earth's gravity contributes to increased penetrator device velocity during water flight;
c) the weight of the penetrator device is related to its overall density and its volume. The drag of the penetrator device is due to the velocity, its shape and volume.
d) The terminal velocity of the penetrator device during water flight ranges between 10 to 80 m s⁻¹

The parameters of the burial depth include:
a) a burial depth of the Penetrator device tail is due to its weight and its terminal velocity;
b) a burial depth of the tail varies between 1 m above the sediment to 50 m into the sediment. Preferable ranges are 1 m above the sediment to 10 m below the seabed;
c) the Penetrator device fully buries in the sediment and the distance of the tail to the seabed substrate is equal to or above 1 m depth;
d) the Penetrator device tail is between 0-1 m depth; and
e) the Penetrator device buries 0 to 60% of its total length.

The parameters of the geological storage include:
a) burial of encapsulated biomass below the sediment in the abyssal plains assures the long-term storage of carbon;
b) any fractional CO₂ that might form from biomass degradation will be trapped into clathrates and not reach the water column;
c) organic carbon buried under sediment avoids contact with oxygen zones which are generally available 10 cm below the seabed, and the benthic biota. This process possesses as a better alternative of ocean CDR that avoids the common risks of ecosystem changed dynamic and leakage of carbon to the surface other CDR methods employed today with the use of algae cultivation and sinkage

The carbon storage capacity assumes that:
d) a Penetrator device storage capacity depends on its internal volume capacity (V), also related to its shape, and its packing material mix;
e) a Penetrator device of L=5.5 m, made of ARB and stores between 100 kg to 2000 kg of CO₂ equivalent;
f) a Penetrator device of L=5.5 m, made of ARB mixed with carbon rich structure stores between 100 kg to 5000 kg of CO₂ equivalent;
g) a L=5.5 m Penetrator device made entirely of C-rich structure will store between 300 kg to 20000 kg of CO₂ equivalent;
h) A Penetrator device of L=1 to 10 m Penetrator device made of different structure (see detailed description) previously described in the will store between 5 kg to 20000 kg of CO₂ equivalent; and/or
i) the C content of a Penetrator device ranges between 3 to 90% by weight.

The full complete description of the present invention is provided by describing engineering and manufacturing processes behind this novel design and its use as a C sequestration technology. Penetrator device is a seafloor penetrator that bury algal material, and or, carbon rich material, and or the plurality of both into the seabed for the purpose of carrying out long-term carbon sequestration.

The algal material used for this technology consists of refined green and brown macroalgae such as Ulva lactuca and Sargassum muticum, but any algal or C-rich material can be used.

Penetrator devices can be filled or directly made with C-rich materials, such as recycled carbonation of MgCO₃, that have a density greater than 1,200 kg m⁻³.

The use of Penetrator devices assumes that large areas of suitable sediments are available, so that there is no need to specify precise locations for each penetrator at this stage. The target areas are abyssal sea plains (˜3,000 to −6,000 m depth) across the world's oceans. The use of a free fall penetrator from surface waters allows minimal impact to the seabed, and its surrounding ecosystem, preventing the application of further technology and operations at the seabed. The simplicity of this method reduces the need of complex engineering systems at depths and reduces the amount of manpower needed to use this technology.

In this facility, ARB material is generated, penetrator devices are packed, and the penetrator devices are loaded onto boats for offshore transportation. Once target sites are reached, the ship would launch the penetrators by casting them overboard. The Penetrator devices would reach velocities up to 80 m s⁻¹ and bury themselves up to 70 m in the sediments. These parameters depend greatly on the penetrator devices density including the weight of the ARB mix or the density of the carbon rich material filling. Field experiments showed that a wet ARB has a lower density (1,220 to 2,000 kg m⁻³) reaching velocities between 14 to 25 m s⁻¹ and a penetration depth between 0 to 5 m in the sediments (distance from tail to seabed). Launch points are designed so that penetrators cannot overlap, and material can spread on the ocean seafloor. An environmental baseline survey will occur prior to the launch to observe the site and locate any obstacles at the seafloor. Penetrators are equipped with tracking devices to verify embedment location and depth.

Structural Material Body, Fins, Tails & Thickness

There will be a small amount of inorganic material added to the penetrator device's body, including, and not limited to, basalt, rocks, clay, organic carbonated shell organisms, such as oysters or other shells, molded and compressed biochar, and a variety of structural variations.

The structural material of the penetrator device refers to any material that composes the penetrator device body, nose, and tail parts.

In certain embodiments, the penetrator device's design structure includes strong fabric, i.e., linen, hemp, biodegradable compostable fabric, for a more exhaustive list please see provisional patent 44165080 incorporated herein by reference.

Another embodiment includes more solid organic and inorganic compounds such as marine or freshwater macroalgae, seaweed, biomass derived from woody or non-woody land-based plants, or combinations thereof. Biomass from woody or non-woody land based plants may include whole crops or waste material including, but not limited to, cellulose, lignocellulose, any grasses (for example, straw), soft wood (for example, sawdust from Pinus radiata), any hard wood (for example, willow, bamboo), any scrub plant, any cultivated plant, corn, maize, switchgrass, rapeseed, soybean, mustard, palm oil, hemp, willow, jatropha, wheat, sugar beet, sugar cane, miscanthus, sorghum, cassava, or any combination of any two or more thereof. Finally, plant material, including but not limited to soy, corn, palm, camelina, jatropha, canola, coconut, peanut, safflower, cottonseed, linseed, sunflower, rice bran, and olive can be used.

Regardless of the exact materials used for the overall structure, ARB packing is carried out with compostable film meeting EU standards EN 13432 or other countries equivalent standards on compostable films, preferably consisting of algae fibers so as to increase ARB pack algal composition of the ARB pack. The packing process includes shrink wrapping, vacuum packing or other common and similar methods to date. Packaging resistance is vital in determining the ARB amount in each Penetrator device. Here, the thickness of the packaging material is adjusted to hold the respective ARB mass.

Further material considerations include C-rich basalt rocks and C-rich clays. In this system, the carbon derives from atmospheric CO₂ captured via DAC systems or liquid CO₂.

In certain embodiments, the Penetrator device body and filling are made of the same material.

In other embodiments, the Penetrator device body and filling are made of different materials.

The thickness of the structure depends upon the total length and the density of the Penetrator device. The longer and the denser the Penetrator device is, the thicker the Penetrator device will be. Please see the examples section for further explanation.

In certain embodiments, the thickness of the L=5.5 m penetrator device structure is made of algal material, and it varies between 3 to 90 cm.

The structure acts as a containment for the C filling. The containment period is expected to last between 0 to 5 years for organic body structure, and 50 to 100 years or biochar carbon, and finally 300 and 1000 years for the mineral type of body structure, after which the engineered barriers are assumed to fail while the sediment continues to function as a geologic barrier to radionuclide migration.

The nose and tail of the structure are constructed from hard structures such as inorganic C-rich material, i.e., inorganic basaltic rocks. Other materials include rigid organic matter such as and non-limiting to bamboo and wood, algal polymer, mentioned in this section.

In certain embodiment is the one where the nose and tail of the Penetrator device are made out from a rigid C-rich structure such as basalt rock, C-rich clay, C-rich magnesium MgO under MgCO₃ via carbonation as described by the Heirloom project (LA, USA), rigid biochar paste made from the pyrolysis of organic matter, and further proprietary processes from the Made of Air project (Berlin, Germany). Further process includes, but are not limited to, C-neutral cement that uses limestone from coccolithophores, marine microorganisms, or other algal residual minerals, concrete mix ratio using algae, hemp and any other organic material described in this section. In such embodiment, the overall volume represented by the body structure, nose, and tail (fins) represent about 10 to about 50% of the overall volume of the penetrator device.

The second preferred embodiment is the one where the penetrator device's nose and tail are made from rigid organic matter such as bamboo, marine or freshwater microalgae, marine or freshwater macroalgae, seaweed, biomass derived from woody or non-woody land-based plants, or combinations thereof. Biomass from woody or non-woody land based plants may include whole crops or waste material including, but not limited to, cellulose, lignocellulose, any grasses (for example, straw), soft wood (for example, sawdust from Pinus radiata), any hard wood (for example, willow), any scrub plant, any cultivated plant, corn, maize, switchgrass, rapeseed, soybean, mustard, palm oil, hemp, willow, jatropha, wheat, sugar beet, sugar cane, miscanthus, sorghum, cassava, or any combination of any two or more thereof. Finally, plant material, including, but not limited to, soy, corn, palm, camelina, jatropha, canola, coconut, peanut, safflower, cottonseed, linseed, sunflower, rice bran, and olive can be used.

In certain embodiments, the penetrator device's body, nose and tail structural material can be soluble or insoluble. When soluble, the dissolution time refers to the time before the body, nose, and tail structure of the penetrator device begin to dissolve in seawater and compromise its structure leading to potential deviation. In any embodiment presented above, the dissolution time of the penetrator device structural material is inferior or equal to the time of the water flight and burial of the penetrator device in the sediment.

In all embodiments, the thickness of the nose and tail fins is defined by the rigidity of the material used. Further information can be found in the example section.

For all embodiments, the Penetrator device structure is not watertight, openings and material are purposely added and chosen to avoid risk of structural damage due to hydrostatic pressure.

### Penetrator Device Internal Material

In one embodiment, the penetrator device is filled with compressed ARB with a density ranging between about 1200 to about 1800 kg m⁻³, or wet ARB with a density ranging between about 1150 to about 1500 kg m⁻³.

In one embodiment, the penetrator devices are filled with an organic carbon biopolymer, either terrestrial or marine, ARB from marine or freshwater microalgae, marine or freshwater macroalgae, seaweed, biomass derived from woody or non-woody land-based plants, or combinations thereof. Biomass from woody or non-woody land based plants may include whole crops or waste material including, but not limited to, cellulose, lignocellulose, any grasses (for example, straw), soft wood (for example, sawdust from Pinus radiata), any hard wood (for example, willow), any scrub plant, any cultivated plant, corn, maize, switchgrass, rapeseed, soybean, mustard, palm oil, hemp, willow, jatropha, wheat, sugar beet, sugar cane, miscanthus, sorghum, cassava, or any combination of any two or more thereof.

In other embodiments, the biomass can be plant material, including but not limited to soy, corn, palm, camelina, jatropha, canola, coconut, peanut, safflower, cottonseed, linseed, sunflower, rice bran, and olive with density varying between 1100 to 1800 kg m⁻³. In such embodiment, the filling is either wet form (20 to 95% moisture), dry form (less than 20% moisture), or dry and compressed form by process described in U.S. Pat. No. 44,165,080.

Drying can be performed with either one or a combination of the following machines but not limited to: evaporation, spray dryer, freeze-dryer, sun-dryer, air dried, tray dryer, rotary dryer, drum dryer, cone screw dryer, double cone dryer, sphere dryer, sludge dryer, granulation dryer and fluid bed dryer. Drying brings the moisture content of the ARB down to a range of about 1 to about 30% (w/w). The temperature and pressure of the drying procedure are selected to minimize the energy consumption of the process. In another embodiment, the ARB is mechanically compressed after the drying process to reach a density in the range of 400 to 1700 kg·m⁻³ with preferred density ranging from 1700 to 2500 kg m⁻³. Compression is performed with one or a combination of the following machines but don't limit to: hydraulic press, forging press, crank press, eccentric press, knuckle joint press, extruder, pelletizer, pellet press, pellet mill, grinder and shredder, briquette press. Preferred methods of drying are sun dried, air dried or tray dried as they are energy efficient and possess a low carbon footprint.

In any embodiment the overall density of the penetrator device in the water column is significantly superior to the ocean seawater density (±1024 Kg·m³) and sink to the ocean floor.

In certain embodiments, the penetrator device filling materials are the same as the body material.

The packed ARB's carbon content is analyzed by laboratory analysis, using HPLC, elemental analyzer or other methods, to record the amount of carbon present in the penetrator device structure, and inner material to quantify the net carbon storage.

In another embodiment, the penetrator device are filled with a mixture of organic matter, such as ARB or terrestrial residues and inorganic matter such as mineral limestones, basalt rocks, compressed biochar matter, but also organic carbon-based shells or a combination of one another.

In another embodiment, the penetrator device are filled with a mixture of ARB and basalt rocks, clay and other rocks that were injected with atmospheric liquid CO₂.

A certain embodiment of the invention is an internal filling material of wet ARB in a rigid structure with thickness volume ranging from about 10 to about 50% of the overall penetrator device volume. The rigid structure is made of C-rich basalt rock, C-rich clay, C-rich MgCO₃, compressed molded biochar. Internal packing material that is richer in carbon compounds and result in more carbon being pack in the Penetrator device is preferable for the sake of the herein invention.

Using wet ARB as filling material is preferable to dry ARB filling even though using wet material requires more energy for transport due to higher water content. The wet content means less energy demand as the drying process is not needed. Air dry method for the ARB is a valid method but is not recommended for large-scale operations as it requires a large land space and can cause issues with emanation being above regulation.

### Penetrator Device Dimension

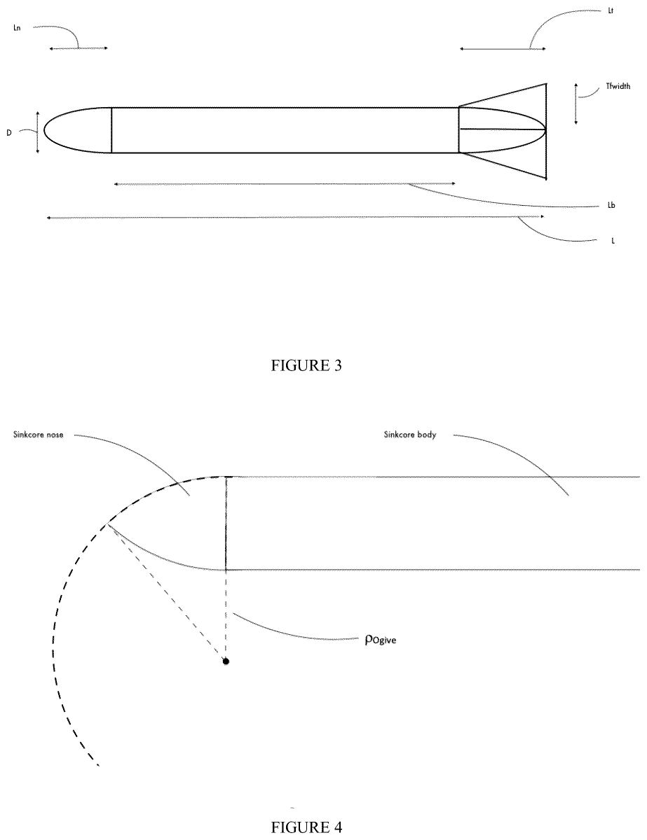

The overall length of the Penetrator device (L) is between about L=1 to about 10 m, preferably L is about 2 to about 5.5 m. The penetrator device body is a conical shape onto which the nose and the tails are joined on each of its sides. The length of the penetrator device (L) equals to the length of the body (Lb) is length the nose (Ln), plus the length of the tail (Lt)⁶, (see FIG. 3), making the overall equation:

L=Ln+Lb+Lt (1)

In certain embodiments, the penetrator device body possesses other geometries other than cylindrical.

The penetrator device body diameter (D) is relative to the length (L) by the L/D ratio. The L/D ratio ranges between about 5 to about 20, with a preferable range of L/D=about 10 to about 15 (see FIG. 4).

The nose is ogive shaped with an ogive radius (r_{Ogive}) value ranging r_{Ogive} is about 1.D to about 8.D, where D is the Penetrator device body diameter. The preferred range of r_{Ogive} is about 1.D to about 3.D (see FIG. 4). The length of the nose (Ln) is defined by the r_{Ogive}.

In other embodiments, the design of the nose is not restricted to the one presented in FIG. 3. Several designs from torpedo, air missile and bullet ballistics publicly available can be used.

The length of the Penetrator device tail (Lt) is defined by the ratio L/Lt⁶, where L/Lt is about 0.3 to about 0.07, preferably with a Lt/L of about 0.15 to about 0.2 (see FIG. 3).

The tail fin width (Tf_{width}) is relative to the Penetrator device length (L) and overall volume (V) and can be expressed as a ratio of the Penetrator device body diameter (D), in the range of Tf_{width} is about 0.8. D to about 1.2. D (see FIG. 3).

The design of the tail is not restricted to the one presented in FIG. 3. Several designs from torpedoes and missiles that are nonproprietary can be used.

Penetrator device overall density (ρ_{Penetrator device}) is relative to the composition of the material used in the structural material and the filling material. In any of the above embodiments, the ρ_{Penetrator device} ranges between ρ_{Penetrator device}=1,200 to 7,500 kg·m⁻³, with preferred range of ρ_{Penetrator device}=1500 to 3 000 kg·m⁻³. The density of the Penetrator device ρ_{Penetrator device} and the volume (V) both act on the Penetrator device overall mass (m_{Penetrator device}). The m_{Penetrator device} affects the terminal velocity, and the burial depth (see the last part of this section).

The Penetrator device overall yield strength is higher than the value at which the burial impact force causes the Penetrator device structure to break.

The Penetrator device overall yield strength (σf_{Penetrator device}) of the Penetrator device depends on its length (L), shape, volume (V), overall density (ρ_{Penetrator device}), and terminal speed (Vi), and ranges between σf_{Penetrator device} is about 20 to about 300 MPa.

### Manufacturing Cost And Emission

The carbon storage overall cost encompassed by the invention combines the penetrator device manufacturing, inner material, and operational costs. For all embodiments, the overall cost must be inferior to the value of the C it contains (see example section). The C value depends on its source: atmospheric CO₂ removal or avoided C emissions. The cost of carbon from atmospheric CO₂ removal ranges between $600 to $1000 per tCO₂ and between $1.9 per tCO₂ to $4.5 per tCO₂ for avoided C emissions across the USA. Even though carbon value is subject to change following the market, the herein explanation still stands.

The preferred embodiment of the present invention uses atmospheric CO₂ sources.

This invention encompasses the systems enabling the geological storage of carbon in the deep-sea sediment, where the manufacturing of the penetrator device structure can be carried out by project possessing proprietary IP of methods capable of turning liquid CO₂ or atmospheric CO₂ into rigid material described above in this section.

The overall C footprint (CF) of the C storage method combines the CF of the manufacturing process, inner material, and the storage operations. For all embodiments, the overall CF of Penetrator device overall process is inferior to the carbon contained in the Penetrator device (see example section).

The present invention describes the tool enabling the geological storage of carbon in the deep-sea sediment, where the manufacturing of the Penetrator device structure can be carried by entities possessing proprietary IP of methods capable of turning gaseous CO₂ (atmospheric or avoided) liquid CO₂ (atmospheric or avoided), into Penetrator device structural, or filling material described in earlier in this section is highly compatible for integration to the herein invention.

The invention describes a cost of C removal in the ranges of $20 to $150 per ton of CO₂ equivalent.

The herein invention results in an emission to removal ratio ranging from about 0.001 to about 0.1.

### Transport, Burial Zones & Operations

For all penetrator device embodiments, the manufacturing plant of the penetrator device is preferably located in or near a port to facilitate the transport of the final penetrator device product. Penetrator devices are placed in containers which are then loaded into vessels.

In another embodiment, penetrator devices are transported from the manufacturing site to port via roadways or railways.

The penetrator device is preferably transported to the burial zone via seaways on large container vessels.

In other embodiments, finished penetrator devices are transported to the burial zone via roadways, railways, airways, or a combination of a plurality of each.

In certain embodiments, specialized bulk carrier vessels are used for transporting Sinkcores to designated offshore burial zones. These vessels feature a compartmentalization system optimized for spatial efficiency, minimizing void space between individual Sinkcores. Equipped with conveyor belts or similar mechanisms, the vessel allows for efficient loading and unloading directly into the ocean. This specialized vessel simplifies delivery and provides a stable cost structure for CO₂ sequestration, particularly valuable during economically unstable periods like pandemics.

### Sea Vessel Carbon Storage Delivery System

The Transport and Immersion System is optimized for use with the penetrator device, although it can be used with other containers to deliver organic or inorganic matter to the deep sea. The system is designed to be used by any vessel capable of transporting containers on deck (e.g., cargo ships).

The system consists of a modified shipping container of any standard size, or an equivalent structure (see FIG. 6).

In certain embodiments, 1.5 m to 2.5 m length penetrator device will be placed horizontally. In certain embodiments, the penetrator device of length 2.5 to 6 m will be placed vertically in the modified container.

The system comprises one or several mechanical racks where the penetrator device or equivalent container hangs through the means of a fast release hook. Alternatively, the penetrator device or equivalent container can stand on a treadmill. The rack or treadmill can be operated mechanically or manually by an operator or automatically.

The system includes a rack or treadmill extension over the side of the ship to allow the Penetrator device in the container to be released overboard and into the ocean. This extension can include weather-proofing side panels. This extension can include a sleeve chute to ease the fall of the Penetrator device or equivalent container into the ocean. The sleeve chute extends 10 m into the water column directly from under the container. The sleeve chute will be slightly angled to correct the deviation of the Penetrator device generated by the acceleration of the boat.

In another embodiment, the system is suspended 5 m above the sea surface and is slightly angled to correct the deviation created by the boat acceleration on the water body.

The system can be equipped with a GPS and a computer to release the Penetrator device at pre-programmed geographic coordinates. The computer or operator log the geographic coordinates of the release.

In certain embodiments, the delivery system (TDS) is refrigerated to avoid microbial activity of the penetrator device organic filling, and its decomposition, leading to carbon leakage back to the atmosphere.

In the above embodiment, the sea vessel is equipped with the following instruments: GPS, seafloor mapping, echo sounder, eco scanner to provide information on deep-sea sediment conditions and bathymetry.

### Burial Zones and Drop Zone

The drop point is the geographic location where the penetrator device is dropped at the surface of the water column and starts its descent. The penetrator device conducts a vertical flight toward the seabed due to the gravitational force and is further enforced by the hydrodynamic forces of the tail's fins vertical angle. Due to the presence of current in the water column, the penetrator device vertical descent can be subject to trajectory deviation. Moreover, deviation can result from the margin of error of the system correction system created by the acceleration of the sea vessel on the water plane. The burial zone is located below the dropping point and is therefore defined by a circular area in which the penetrator device terminates its descent and starts penetrating in the sediment. The deviation of the penetrator device in the vertical trajectory ranges from 1° to 25° (see FIG. 7A).

The parameters defining a burial zone are established during a field trial phase. The burial zone of a dropping point depends on the shape, size, and velocity of the penetrator device used, but also by the physical factors of the water column at the time of the flight, such as the current, the density of the water. Safe burial zone areas are calculated by taking the most significant deviation data and adding an additional safety margin of error for penetrator device deviations in the water column during flight.

Each drop point will correspond to a burial zone (see FIG. 7A). Several points of drop create a drop zone. A burial area is defined by each drop zone (see FIG. 7 B).

Carbon buried in sediment is considered geologically stored only if the cumulative risks affecting the operation result in a probability of 90 to 99% that the carbon will be trapped at a geological time scale as a result of the sum of the factors cumulative risks affecting the operation.

The burial zone must meet specific characteristics to become a valid burial zone for operation (see section 110 below). It is the validity of the burial area that determines the validity of a dropping zone.

The depth of the water column required for the Penetrator device water flight (see FIG. 7 B) ranges from 30 to 8500 m depending on the penetrator device's size and density. It is preferred that the depth is equal or above the depth at which the Penetrator device has reached terminal velocity. The depth of the water column preferably ranges between 1000 to 4000 m, as this area of ocean floor is generally less prone to seismic events. The water bodies understand, ocean, seas, dead seas, lakes, or rivers.

The penetrator device highway is the area that links the drop point to the burial zone. It is the area where the Penetrator device carries its water flight. The penetrator device highway must be free of any structural obstructions such as fishing lines, buoys, and erratic glaciers.

The sea vessel drop zone corridor is the drop zone that is possible to operate while the vessel is in movement.

The vessel's seismic profiling tool defines in real time the safety to operate off the drop zone corridor, in terms of free penetrator device trajectory pathway, and seismic record of the sediment layer.

The burial zone marks the start of the penetrator device penetration layer. The Penetrator device penetration layer is the space where the penetrator device buries into. The Penetrator device penetration layer is located under the burial layer, but also extended on its side by the deviation potential defining the penetrator device trajectory column (see FIG. 7 C). The safety of a burial zone is defined by the safety of operation of the penetrator device penetration layer.

The penetrator device penetration layer presents a zone void of seismic activity for more than 1 million years (such as hydrothermal vents, continental plates) as seismic events could result in pushing out the penetrator device back on the seabed, hence negating the purpose described in the herein invention. The preferred burial zones are deep ocean seabeds between 1000 to 6500 m depth. In another embodiment, a shallower depth can be considered if C leaking to the surface from the ARB is proven nonexistent.

According to the previous embodiment, zones that possess a 95% or higher interval probability interval for seismic stability correspond to the year during which carbon is stored. Such value varies from 5000 years to close to permanent timescale.

The penetrator device burial layer must possess the following characteristics: it must be made entirely of a certain range of soft sediment, hence, free of any rocks diapirs.

For the penetrator device's tail to bury at the desired depth and store C for long period of time, the sediment must be composed soft mud with particles size between 2 to 50 microns and permeability in the range of 10⁻³ cm s⁻¹ for coarse turbidites to 10⁻⁸ cm s⁻¹ for fine pelagic clays from the West Pacific as described by Freeman et al., 1986.

The sediment should have the following properties for the Penetrator device to bury. The types of sediment include clay, calcareous ooze, etc. Moreover, it should be thick, weak, homogenous sediment of very fine particle size.

Due to their chemical composition, particle size, low permeability, and apparent stability, these sediments provide the geologic barrier to carbon dispersal.

As part of proper emplacement, the penetrator device is delivered beneath the seafloor in such a way that the natural barrier properties of the sediment isolate the carbon until it has re-mineralized sufficiently to present a negligible risk if it escapes.

In one case example, turbidites from the continental rise can be found in sediment layers. Turbidites can be fine-grained at the top, while silt can be found at the bottom of the sediment layer ±10 m. Marly oozes generally contain 30 to 50% silt, carbonate, and 10 to 20% clay minerals, as well as 0.1 to 1.0% organic carbon. There are 30 to 90% carbonate layers intermixed with basalt in the silty fragment's layer. Turbidites in the sediment layers tend to have higher carbonate contents. Within the area of example, the mean grain size and standard deviation of all turbidites are 3.4±0.5 μm. Throughout the study area, fine-grained layers have similar grain sizes, while silty bases have grain sizes up to 40 μm.

The grain size ranges from less than 4 μm to clay, resulting in low permeabilities. Permeabilities for the first 25 m below the sediments are 5 to 7, 7 to 8, 8 to 10 and 10 to 12 cm s⁻¹. Below 25 m, permeability is 10 to 10 cm s⁻¹, except in the carbonate oozes, where permeability is given as 10⁶ cm s⁻¹ (Shephard et al, 1987).

The upper 10 m of sediment without silt laminations have been found to be subject to bioturbation. Animal disturbance in these intervals can leave infilled burrows or mottling on over 50% of the structure.

In another embodiment, when sulfur is abundant, the organic carbon within Sinkcores undergoes a sulfur-driven decomposition pathway, differing from typical aerobic or anaerobic decomposition. This results in compounds like hydrogen peroxide and allows for shallower burial depths, provided that complete penetration into the seabed is achieved. In a subsequent embodiment, the decomposition process continues through the sulfur cycle until sulfur concentrations become limited, initiating methanogenesis. This dual-phase decomposition allows for flexibility in burial depth and sediment type, expanding suitable sequestration sites.

### Area Between Drop Point

The C-content of one ARB is quantified using elemental analysis HPLC (or other methods). The value of the carbon stored by a penetrator device is higher than its manufacturing cost and sinking operation.

The distance between each penetrator device dropping point ranges from 5 to 1000 m depending on the size of the penetrator device and its C-content.

Smaller quantities of ARB spread over a great distance is the preferred method. In the eventuality that a penetrator device does not successfully bury, we assume a radial affected area where the input of C into the surrounding environment does not exceed 0.25-2.5 g m⁻² y⁻¹. This value corresponds to predicted depleted C quantities reaching the ocean floor by 2100 by Sweetman et al, and therefore does not possess CDR technology but a Conservative & CDR technology (CCDR)¹⁶.

The safety of the spacing distance is measured accordingly with the cumulative risk of leakage. The cumulative risk of carbon leaking from the Penetrator device back to the seabed should be 0 to 5%. The probability of carbon being stored for an extended period of time in the deep sea is 95% or higher. The spacing distance acts as a safety net ensuring 95% confidence that the C leaked into the environment does not pose a threat to the deep-sea environment.

A more complete understanding of the present invention will be provided in relation to the following examples which are understood to be non-limiting to the basic inventive concepts of the present invention. The monitoring of the ARB is achieved by a system according to the ISO international standards.

### Water Flight & C-Storage Parameters

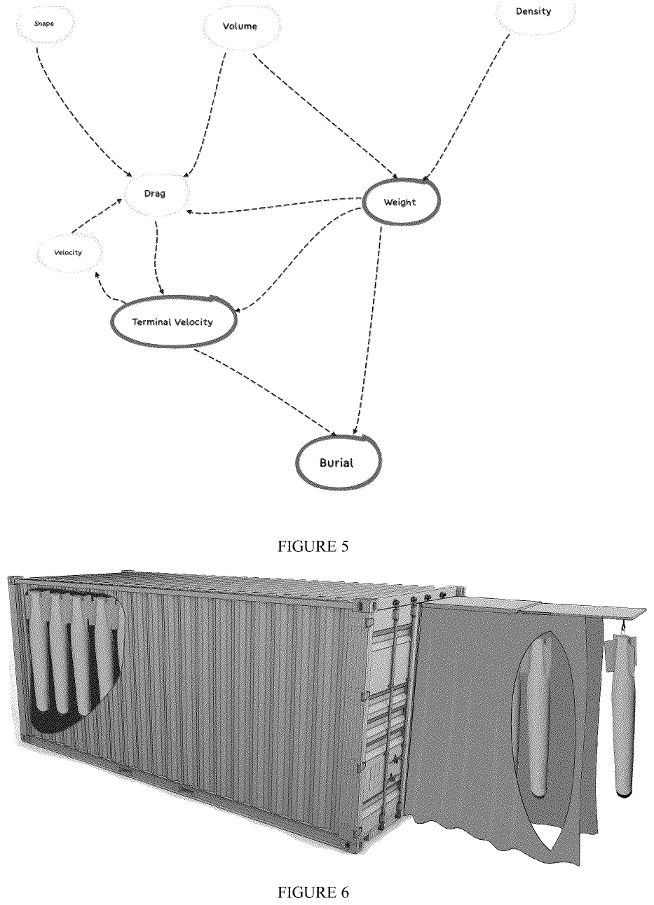

The terminal velocity is affected by the weight and drag of the penetrator device. The weight of the Penetrator device is related to its overall density and its volume. The drag depends on velocity, shape, and volume (see FIG. 5). It is described by Freeman et al., (1986). The terminal velocity (Vₜ) of the Penetrator device during water flight ranges between Vₜ=10 to 80 m s⁻¹, preferably in the range of Vₜ=18 to 30 m s⁻¹ to assure the burial of the carbon in the sediment.

The penetrator device velocity increases during water flight by the earth core gravitational force.

The penetrator device's minimal water flight distance is the minimal depth at which the Penetrator device buries Minimal water flight distances are defined by the depth at which the Penetrator devices reach their terminal velocity.

### Burial Depth

The burial depth of the penetrator device tail is due to its weight and its terminal velocity (see FIG. 5). It is described by Freeman et al., (1986). The burial depth of the tail varies between 1 m above the sediment down to 50 m below the sediment. The preferred depth ranges between 1 m above the sediment to 10 m below the seabed.

The preferred scenario describes the penetrator device fully burying in the sediment with the tail burying at least 1 m below the seabed.

Finally, in another scenario the penetrator device buries 0 to 60% of its total length. In such case the part that is not buried is made of material that is contaminant free to the benthic ecosystem such as PCBs dioxins, mycotoxins, heavy metals (as described by the JRC in the potential chemical contaminants in the marine environment; the EPA in the National Recommended Water Quality Criteria, or similar country legislation²¹). In this scenario the non-buried material is made of inorganic material such as limestones, mineral clay, compressed molded biochar described to the previous section.

In all scenarios, 5 to 30% of the penetrator device tail section is composed of non-organic C with the characteristics described in the previous section. The non-organic tail section acts as a barrier for the organic carbon and participates in its low remineralization rate lowering the cumulative risk of disturbance to deep-sea ecosystems.

### Geological Storage

For all the penetrator device structures, the organic matter is buried in deep-sea sediments away from biological interactions. Burial of C-rich material reduces the risk of fast remineralization into organic compounds, resuspension in the water column, and eventually return to the surface to the atmosphere by the thermohaline circulation.

The burial of encapsulated biomass below the sediment in the abyssal plains assures the permanent storage of carbon. The biomass encapsulation offers physical protection against grazing by macrofauna and meiofauna, which would already be limited due to the low total biomass present (Chih-Lin Wei et al., 2010). Low temperatures and high pressures compromise bacterial enzymatic processes resulting in slower degradation rates (Turley CM, 2000, de Jesus Mendes et al, 2007). The biogeomimetic approach described in the herein invention protects the organic matter exudating from our biomass from bacterial degradation (Hedges et al, 2001, H Cheng, et al, 2012).

Any fractional CO₂ that might be formed by degrading our biomass will be trapped into clathrates, not dissolving into the water column (Qureshi et al, 2022). The technology discussed in this patent uses a friendly environmental approach enhancing natural processes already present in the ocean and exploiting algae natural power to intake CO₂ avoiding injecting non-native compounds into the seabed. When our naturally occurring algae will be buried into the seabed below 1,000 m depth, the carbon contained in their biomass will be sequestered at geological timescales, by slow remineralization of the organic carbon to inorganic form.

The organic carbon buried circa 10 cm below the seabed avoids contact with oxygen zone and the benthic biota. This process represents a better alternative of ocean CDR that avoids the common risks of changing ecosystem dynamics and leakage of carbon back to the surface that other CDR methods employ today. The advantages presented in this patent ensure significantly longer sequestration times, estimated to be in the range of millions of years.

For Life Cycle Assessment (LCA) optimization, sustainable shipping companies

are utilized and introduce a new step for biomass drying using a specialized sludge sun dryer. This eliminates the need for external hemp tissue, reducing the average cost of carbon storage from about $90 to $75 per ton of CO₂. The inclusion of enhanced weathering limestone can further reduce this cost to $60 per ton of CO₂.

### Carbon Storage Capacity

Storage capacity depends on penetrator device's internal volume capacity (V), shape (see FIG. 5), and its packing material mix. Examples can be read in the following section.

In certain embodiment, a L=5.5 m penetrator device made of ARB and stores between 100 to 2000 kg of CO₂ equivalent.

In certain embodiments, a L=5.5 m Penetrator device made of ARB mixed with carbon rich structure stores between 100 to 5000 kg of CO₂ equivalent.

In certain embodiments, a 5.5 m Penetrator device made entirely of carbon rich structure will store between 300 to 20000 kg of CO₂ equivalent.

In certain embodiments, a L=1 to 10 m Penetrator device made of different structure previously described will store between 5 kg to 20000 kg of CO₂ equivalent.

The carbon storage capacity of a penetrator device is mostly defined by its overall carbon content. The carbon content of a penetrator device is defined by its emission (see the first part of this section). The carbon content of a penetrator device is expressed in mass percentage (m_{carbon} of the Sinkco over its mass (m_{Penetrator device}).

The carbon content of a penetrator device ranges between 5% to 100%.

The preferred embodiment is a higher carbon content of the Penetrator device between 50 to 99%.

### EXAMPLES

### Example 1: 5.5 m Long Penetrator Device Using Organic Fabric

A L=5.5 m Penetrator device with D=0.55 m diameter (L/D=10), and internal volume V=1.3 m³ was filled with 70% ARB (as described in the section of provisional patent 44165080), 30% oyster shell (density of 1625 kg·m⁻³) to give an overall density of 1372 kg·m⁻³ (with an original 1220 kg·m³ ARB density), to give an overall weight of 1783 kg. The Penetrator device reached a terminal velocity of 15.3 m·s⁻¹ (54 km·h⁻¹). The drag force measured was 0.19 empirically would result in a 65% burial of the nose.

### Example 2: 5.5 m Long Penetrator Device Oxide Mineral Concrete Penetrator Device

A 5.5 m Penetrator device with a diameter of 0.55 m diameter (L/D=10), and internal volume of 1.8 m³ filled with 70% ARB, with a density 1220 kg m⁻³ (as described in the section [00210] of provisional patent 44165080), 30% green concrete (density of 2625 kg m⁻³) to give an overall density of 1641 kg m⁻³, to give an overall weight of 2181 kg. The Penetrator device reached a terminal velocity (20 m s⁻¹, 72 km h⁻¹). The drag force measured empirically 0.163. Further data are summarized in table 2.

TABLE 2
Summary of the characteristics of a 5.5 m long Penetrator Device.

| Properties | Values | Units |
|---|---|---|
| Length (L) | 5.5 | m |
| L/D ratio | 10 | |
| Diameter | 0.55 | m |
| Ln/L | 0.15 | |
| Ln (length of the nose) | 0.81 | m |
| Ogive ratio to diameter | 2 × D | |
| Lt/L | 0.185 | |
| Lt (fins length) | 1018 | mm |
| Fin width on each side | 550 | mm |
| Angle fins | 35 | degrees |
| Internal volume | 1.1778 | m³ |
| Overall density | 1642 | kg m³ |
| Mass | 1933 | kg |
| Gravitational acceleration | 9.8 | m s⁻¹ |
| Weight force (W) | 7055 | N |
| Density ocean water | 1029 | kg m³ |
| Frontal area drags coefficient (Cd) | 0.163 | |
| Frontal area | 0.238 | m² |
| Terminal velocity | 18.8 | m s⁻¹ |
| 90% terminal velocity | 16.9 | m s⁻¹ |
| 80% terminal velocity | 15.1 | m s⁻¹ |
| Burial depth of the nose | 6.0 | m |
| Burial of the tail | 0.5 | m |
| Burial percentage | 110 | % |

### Storage Operation

A 20 foot container was filled with 16× penetrator device of 5.5 m length in a vertical position. Penetrator devices are attached at the end with quick releases. The container was boarded on a container vessel. The vessel is navigated to an area of drop described in the detailed description section. In this field trial, the ship was static, Penetrator devices were released every 200 m.

The manufacturing of the penetrator device structure was commissioned to Heirloom resulting in a 3.8 cm thick C-negative concrete structure.

The whole process is responsible for emitting about 15 kg of CO₂ eq per penetrator device.

Storage Capacity

The penetrator device internal volume was filled as 70% ARB and 30% green concrete and contained 110 kg of organic carbon captured from the atmosphere by the algae biomass (Table 3). For the penetrator device structure, algae residual minerals were used to produce concrete with 35% cement. Penetrator devices contained 208 kg of algal mineral, equivalent to 109 kg of CO2 (Table 3).

TABLE 3
Summary of the carbon compounds
in a L = 5.5 m Penetrator device.

| Penetrator device Compounds | Value | Units |
|---|---|---|
| Weight ARB | 1006 | kg |
| Moisture | 73 | % |
| dry ARB | 268 | kg |
| Carbon ration | 41 | % |
| Carbon | 110 | kg |
| CO_{2 ARB} | 402 | kg of CO_{2 eq} |
| Weight of algae mineral | 208 | kg |
| Carbon ration | 14 | % |
| Carbon | 30 | kg |
| CO_{2 ARB} | 109 | kg of CO_{2 eq} |
| Total CO_{2 Penetrator device} | 511 | kg of CO_{2 eq} |

Emission to removal ratio for the CDR storage using penetrator device technology in the present invention is 0.008, which is much more efficient than the current 0.05 ratio for DAC techniques. With the algae-based carbon capture and penetrator device storage, the overall emission-to-removal ratio is 0.06.

The overall cost per ton of CO₂ stored gave a $121 per ton of CO 2 eq, which is relatively high compared to other techniques because the green mineral concrete was commissioned and the carbon it contained had to be acquired at the current market price, which is currently 400$ per ton of CO₂ equivalent.

### Example 3: 5.5 m Long Penetrator Device Algae Based Concrete

A 5.5 m Penetrator device with a 0.55 m diameter (L/D=10), and internal volume V=1.8 m³ was filled with 70% ARB (as described in the previous example), 30% Green concrete (density of 2625 kg·m⁻³) to give an overall density of 1641 kg·m⁻³ (with an original 1220 kg·m³ ARB density), to give an overall weight of 2181 kg. The Penetrator device reached a terminal velocity of 20.0 m·s⁻¹ (72 km·h⁻¹). The drag force measured was 0.163 empirically. Further data are summarized in table 2 in the previous section.

### Storage Operation

A 20′ foot container was filled vertically with 16 Penetrator device of L=5.5 m length. Penetrator device is attached from the end with a quick release system. The container was boarded on a small container vessel. The vessel is navigated to an area of drop described in the detailed description section. The container was brought to the side of the sea vessel using its onboard crane system. While the ship was static, each Penetrator device was released at a distance of 0.2 km each.

### Cost Manufacturing and Emission of the Penetrator Device

Algae residual minerals were used to produce a concrete with 35% cement for the Penetrator device structure of 3.8 cm thickness. The emissions of the process were established at 50.5 Kg of CO₂ eq per Penetrator device.

### Storage Capacity

The Penetrator device internal volume was filled with a mixture of 70% ARB, 30% green concrete, and contained 110 kg of organic carbon captured from the atmosphere by the algae biomass (see table 3). The Penetrator device contained 208 Kg of algal mineral representing 109 kg of CO₂ eq per Penetrator device (see table 3 of the previous section).

The Emission to removal ratio resulted in 0.078 for the CDR storage using the Penetrator device technology described in the herein invention, which is similar in performance to the current 0.05 ratio of DAC techniques. Overall, with the carbon capture via algae to make the ARB, and the storage using the Penetrator device result in a 0.042 emission to removal ratio, which is similar to the current performance related to the project.

The overall cost per ton of CO₂ stored gave a $48 per ton of CO₂ eq. And this cost is relatively similar to other company projections.

What is claimed is:

1. A system for the permanent storage of carbon in the ocean using a freefall penetrator device comprising of:
a. a tube-like device capable of delivery to the ocean floor and penetrating the ocean floor; and
b. a hollow internal portion capable of containing carbon waste.

2. The system of claim 1, wherein the system allows a cost and energy efficient tool for ocean CDR that stores and sequesters atmospheric carbon for a period of time with minimal risk of harm to the deep-sea benthic ecosystem.

3. The system of claim 1, wherein the carbon stored is atmospheric and/or from anthropogenic activities and it is stored for a period of time to allow removal of carbon from the atmosphere.

4. The system of claim 1, wherein energy efficiency methods are used and wherein carbon storage capacity is increased, emission to removal ratio is reduced, and carbon offset value increases.

5. The system of claim 1, wherein the penetrator device for ocean carbon dioxide removal (CDR) generates C-offset by the removing atmospheric CO₂ and permanently disposing of C-rich materials.

6. The system of claim 1, wherein the penetrating device is comprised of organic and/or inorganic carbon, or a combination thereof and results in no harm to the ecosystem and does not affect any ecotoxicity for the food chain by bioaccumulation of harmful compounds.

7. The system of claim 1 wherein the penetrator device allows the potential of using organic waste carbon with no required process.

8. The system of claim 1, wherein the penetrator device comprises a size greater that 1.5 L volume capacity, carbon content, carbon storage capacity, and a cost efficiency as a CDR storage composition.

9. The system of claim 8, wherein the penetrator device has a volume of about 3 L or more.

10. The system of claim 1, wherein the penetrator device dimensions and density allow penetration into the seabed and long-term storage of its carbon content material.

11. The system of claim 10, wherein the penetrator device has a cumulative risk between 1 and 10%.

12. The system of claim 1, wherein the penetrator device has a length of about 1 to about 5 m and L/D ratio between about 8 and about 15, and a density higher or equal to about 1000 kg·m⁻³.

13. The system of claim 1, wherein the penetrator device manufacturing plant has direct access to the seaway.

14. The system of claim 1, wherein the penetrator device is comprised of external material and internal filling made directly to capture carbon into structural material, which can greatly benefit from the carbon storage system.

15. The system of claim 1, wherein penetrator device includes a mechanism to allow delivery of to the burial zone of the ocean from a boat.

16. The system of claim 1, wherein the penetrator device is included in modified containers for the transport by sea and such modified containers are equipped with quick release hooks or similar that are loaded at a later stage.

17. The system of claim 1, wherein the penetrator device comprises a tail that allows the composition to penetrate into the sediment about 1 to about 30 m depth to allow a long-term storage of C.

18. The system of claim 1, wherein the penetrator device stored in the deep-sea sediment avoids the disturbance to the benthic ecosystem, shorter storage of the carbon due to is respiration (organic carbon) or leakage for inorganic carbon in the seabed water bodies and return to the surface with the ocean thermocline cycle.

19. The system of claim 1, wherein the delivery operation of the penetrator device uses a spacing distance for flight that allows to diminish the overall cumulative risk of composition to resurface.

20. The system of claim 1, wherein the penetrator device manufacturing cost, its size, and its carbon content are the most important factors defining the efficiency of such inventions of ocean CDR.

21. The method of claim 1, wherein step c allows for the storage of a ton of CO₂ equivalent with an emission-to-removal ratio of 0.001 to 0.1.

22. The method of claim 1, wherein the manufacturing cost, size, and carbon content of the Sinkcore define the efficiency of this ocean CDR.

23. The method of claim 1, wherein sulfur abundance in the burial site affects the decomposition pathway of the Sinkcore's organic carbon, allowing for different byproducts and burial depths.

24. The method of claim 1, wherein methanogenesis occurs when sulfur concentrations are limited, allowing flexibility in burial depth and sediment type.

25. The method of claim 1, wherein an optimized drying process using a sludge dryer and direct compression of the organic biomass into rigid-shaped free-fall penetrators avoids the need for manufacturing an outer shell layer and potential fins, aiming to reduce costs and emissions.
